(19) United States
(12) Patent Application Publication
(10) Pub. No.: US 2010/0301679 A1
(43) Pub. Date: Dec. 2, 2010

(54) SENSOR WITH SELECTABLE SENSING ORIENTATION USED FOR CONTROLLING AN ELECTRICAL DEVICE

(76) Inventors: Peter Grahame Murray, Victoria (AU); Jeffrey Laurance Jackel, Victoria (AU)

Correspondence Address: MAIER & MAIER, PLLC, 1000 DUKE STREET, ALEXANDRIA, VA, 22314, US

(21) Appl. No.: 12/376,336

(22) PCT Filed: Aug. 9, 2006
(86) PCT No.: PCT/AU06/01133

§ 371 Date: Aug. 18, 2010

(30) Foreign Application Priority Data
Aug. 11, 2005 (AU) 2005904340

(51) Int. Cl. H01H 35/00

(52) U.S. Cl. 307/116

(57) ABSTRACT

A device designed to be plugged directly into a household power supply socket comprising a sensor for controlling an electrical device, the sensor having selectable sensing orientation and being one of a motion detector, an infrared detector, a photodetector or a sound detector, whereby the sensor generates a control signal to the electrical device, the electrical device being one of a light bulb, a mobile telephone, a security device such as a sound or burglar alarm, or a monitoring device such as a surveillance camera, upon detection of a change in an environment, e.g. movement, ambient light, sound, etc.

### FIELD OF THE INVENTION

The present invention relates to a portable device. In particular, the present invention relates to a portable device for controlling an electric device.

In the context of this specification, “gimbal” means a device with two mutually perpendicular axes of rotation, thus giving free angular movement in two directions, on which an object may be mounted.

### BACKGROUND OF THE INVENTION

In recent years, various automatic switching devices have been marketed, which function to switch lighting on and off, depending on some sensed condition. For example, an ambient light level sensor may be incorporated into the switching device so as to switch on the light when the ambient light falls below a certain level (e.g. when night falls). Alternatively, there may be a motion sensor for detecting motion within a particular field of view of the detector and switching the light on when motion is detected.

One known motion detector arrangement for switching lighting has a housing that is typically located in a fixed in place (e.g high up on an external wall). The known sensor is typically wired connected to the mains power supply during installation. This arrangement is relatively expensive and requires installation by an electrician. Additionally, the installation is not easily moved once it is fixed in place and wired into the mains power supply.

U.S. Pat. No. 4,823,051 by Young describes an infra-red actuated control switch assembly. This assembly has a motion detecting capability and is housed within a plug and socket adaptor to be interposed between a light bulb and a socket in normal domestic applications. The sensing system described by Young has a 360° range in the horizontal plane, with two separate sensing fields in a vertical field of view. This arrangement may not, however, allow for the field of view of the motion sensor to be directionally targeted. Thus, in situations where it is not desired to switch the light based on motion in a certain part of the room, the light will nonetheless be undesirably switched on. Thus, the 360° range of the assembly described by Young lacks directional adjustability and may inconveniently switch on when not desired.

The above-described automatic detector devices are typically located in fixed positions and may not be readily movable. As such, the mentioned detector devices may not be easily located in positions to detect specific events. For example, a wall mounted sensor may be able to turn on a light when it detects that a person has walked into a room. However, the wall mounted sensor may no be able to turn on the light only when a person sits up in bed, for example. It may not be convenient in a hospital ward, for example, for the main light in a room to turn on upon detection of a person entering the room. Rather, the light may need only come on when a patient sleeping in the room sits up in bed, or sets foot on the ground, for example.

It is generally desirable to overcome or ameliorate one or more of the above-described difficulties, or at least provide a useful alternative.

The reference to any prior art in this specification is not, and should not be taken as, an acknowledgment or any form of suggestion that that prior art forms part of the common general knowledge in Australia.

### SUMMARY OF THE INVENTION

In accordance with one aspect of the invention, there is provided a portable device for controlling an electric device, including a sensor responsive to changes in an environment, wherein said sensor generates a control signal for said electric device on detection of a change in said environment.

Preferably, the portable device includes a jack for electrically coupling the electrical device to the portable device, wherein the sensor electrically couples the jack to a power source on detection of said change.

Preferably, the sensor is adapted to be interconnected between the electric device and the jack.

Preferably, the sensor is an adaptor including a gimbal mounted sensor.

Preferably, the adaptor includes:
(a) a sensor;
(b) a gimbal housing having a male connector at one end and a female connector at another end, wherein the male connector is configured to connect with an electrical socket and the female connector is configured to connect with an electrical device; and
(c) a circuit for selectively controlling the electrical device in response to the sensor;

wherein the gimbal housing is adapted to rotate around the male connector about a first axis and support the sensor for independent rotation about a second axis perpendicular to the first axis so that the sensor can be moved to a selectable sensing orientation.

Preferably, the sensor is electrically coupled between the power source and the jack.

Preferably, the sensor is adapted to rotate about an lateral axis with respect to the base member.

Preferably, the sensor includes one of a motion detector, an infrared detector, a photodetector and a sound detector.

In accordance with yet another embodiment of the invention, there is provided a method for monitoring a person using the above-described portable device, including the step of arranging the sensor of the portable device to monitor a predetermined area proximate said person, wherein said portable device is adapted actuate an electric device upon detection of a change in said predetermined area.

### BRIEF DESCRIPTION OF THE DRAWINGS

Preferred embodiments of the present invention are hereafter described, by way of non-limiting example only, with reference to the accompanying drawings, in which:

FIG. 1 is a front view of an adaptor according to one embodiment of the invention;

FIG. 2 is a side view and schematic representation of the adaptor of FIG. 1;

FIG. 3 is a side view and schematic representation of the adaptor of FIG. 1, with the motion detector rotated into an alternate position;

FIGS. 4A, 4B and 4C show a plug part of the adaptor, illustrating the configuration of a locking pin and locking plate associated with the plug;

FIG. 5 is a partial cut-away view of the adaptor;

FIG. 6 is a front view and schematic diagram of an adaptor of another embodiment of the invention;

FIG. 7 is a perspective view of an adaptor of another embodiment of the invention;

FIG. 8 is a partial cut-away view of the embodiment of FIG. 7 showing the locking mechanism;

FIG. 9 front view of a portable device;

FIG. 10 is another front view of the portable device shown in FIG. 9 showing, in broken lines, the internal parts of the device coupled to an electrical device;

FIG. 11 is an exploded view of some of the parts of the portable device shown in FIG. 9 coupled to an electric device;

FIG. 12 front view of another portable device coupled to an electric device, as shown in broken lines;

FIG. 13 side view of the portable device shown in FIG. 12 coupled to an electric device, as shown in broken lines;

FIG. 14 is another side view of the portable device shown in FIG. 13 showing the internal parts of the device in broken lines;

FIG. 15 front view of yet another portable device coupled to an electric device, as shown in broken lines;

FIG. 16 is another front view of the portable device shown in FIG. 15 showing the internal parts of the device in broken lines; and

FIG. 17 front view of still another portable device coupled to an electric device, as shown in broken lines.

### DETAILED DESCRIPTION OF THE PREFERRED EMBODIMENTS

In this specification, and specifically including the description and drawings, like reference numerals indicate like features, functions or parts, unless otherwise indicated.

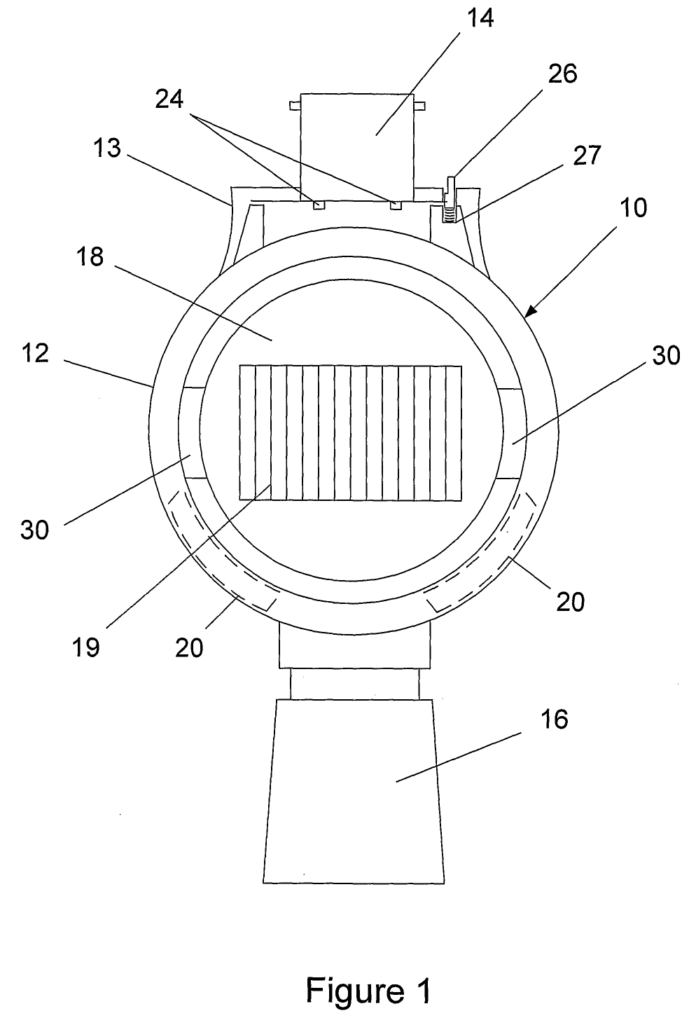

Referring to FIGS. 1 to 3, there is shown an adaptor 10 having a housing 12 of a generally shallow cylindrical shape. A motion detector 18 (also termed a motion sensor) is located within the cylindrical body of the housing 12 and connected thereto by housing connectors 30. The housing connectors 30 allow rotation of the motion detector 18 relative to the housing 12 about a lateral (or generally horizontal) axis extending through the housing connectors 30 and the center of the motion detector 18.

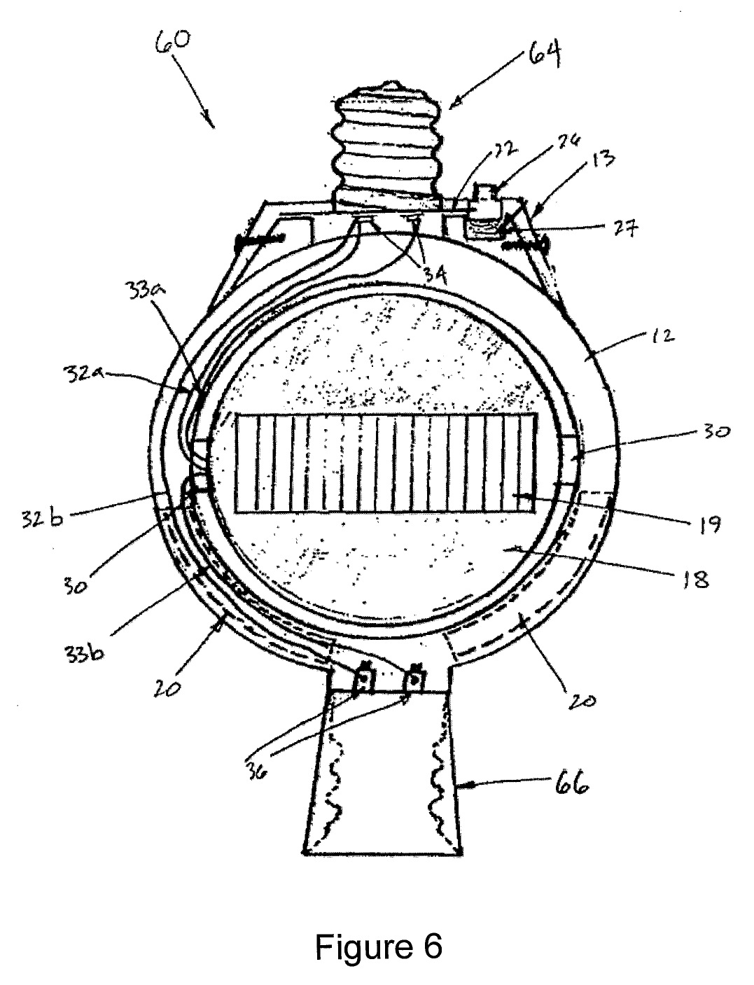

At a top end of the housing 12 is mounted a top housing part 13 having a plug part 14 connected thereto. The plug part 14 is configured to be inserted into a light socket such as is commonly used for domestic lighting in Australia. The arrangement or configuration by which the plug part 14 engages with a socket may be modified to suit the type of domestic lighting connections prevalent in different countries. For example, FIG. 6 shows an alternative embodiment of the adaptor having a screw in plug part 64 in place of the plug part 14 of FIGS. 1 to 4.

The top housing part 13 may be integrally formed with housing 12 or separately formed and connected thereto by conventional means, such as adhesive or mechanical attachment. The top housing part 13 serves to provide a substructure of the housing 12 within which the plug part 14 may rotate relative to the housing 12 about a longitudinal axis of the adaptor 10.

Plug terminals 34 are arranged on the underside of the plug part 14 and concealed within the top housing part 13 for connecting conductors thereto by which power is provided to a light bulb fitted into socket part 16.

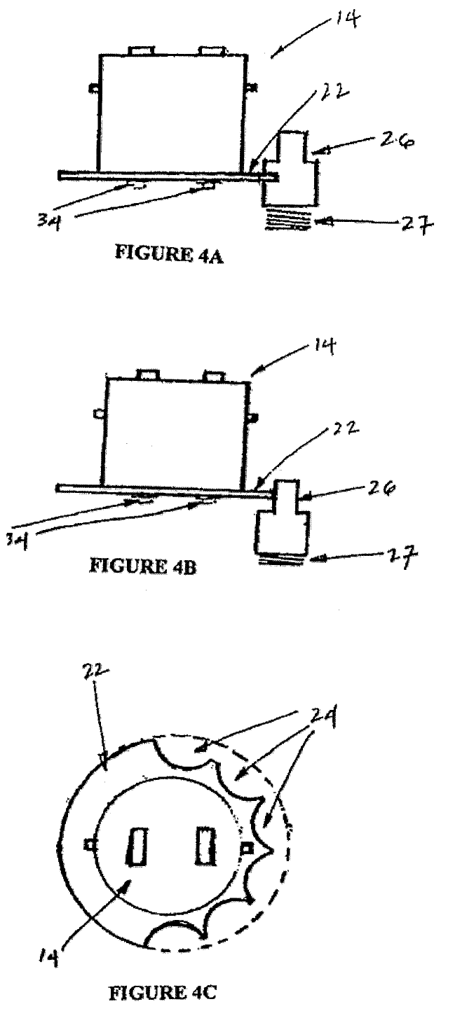

The top housing part 13 also accommodates a locking pin 26 which engages with a locking plate 22 on the bottom of the plug part 14. The locking pin 26 moves within a channel in the top housing part 13 and is biased by a spring 27 into a normal extended position in which it engages with the locking plate 22 to prevent rotation of the plug part 14 relative to the housing 12. This is illustrated in more detail in FIGS. 4A, 4B and 4C. When the locking pin 26 is depressed, compressing the spring 27, it moves into a retracted position in which it does not engage with the locking plate 22, thus freeing the plug part 14 to rotate relative to the housing 12.

The locking plate 22 has a number of recesses or depressions 24 therein which engage with the locking pin 26 when it is in its extended position. In the exemplary embodiment illustrated in FIGS. 4A to 4C, the locking pin 26 is formed so as to have a base portion formed larger than a top portion. In its extended position, the base portion of the locking pin 26 fits generally into one of the recesses 24 in the locking plate 22. The locking pin 26 is only allowed to move between its extended and retracted positions and is fixed against movement in the plane of the locking plate 22, such that in its extended position, the locking pin 26 fits into a recess 24 and prevents rotational movement of the locking plate 22. In its retracted position, the top part of the locking pin 26 is sufficiently small so that it does not engage with any of the recesses 24, thus allowing rotational freedom of the locking plate 22. However, the top part of the locking pin 26 is still formed sufficiently large to prevent rotation of the locking plate 22 beyond about 90° in each direction by interfering with circumferential parts of the locking plate 22 which do not have recesses 24 formed therein. Other arrangements may be employed for fixing the plug part 14 against rotational movement and preventing rotation beyond about 180°.

On an opposite part of the housing 12 to which the plug part 14 is connected, there is formed a socket part 16 for receiving a light bulb (not shown). The socket part 16 is adapted to receive light bulbs having a plug configuration corresponding to that of plug part 14.

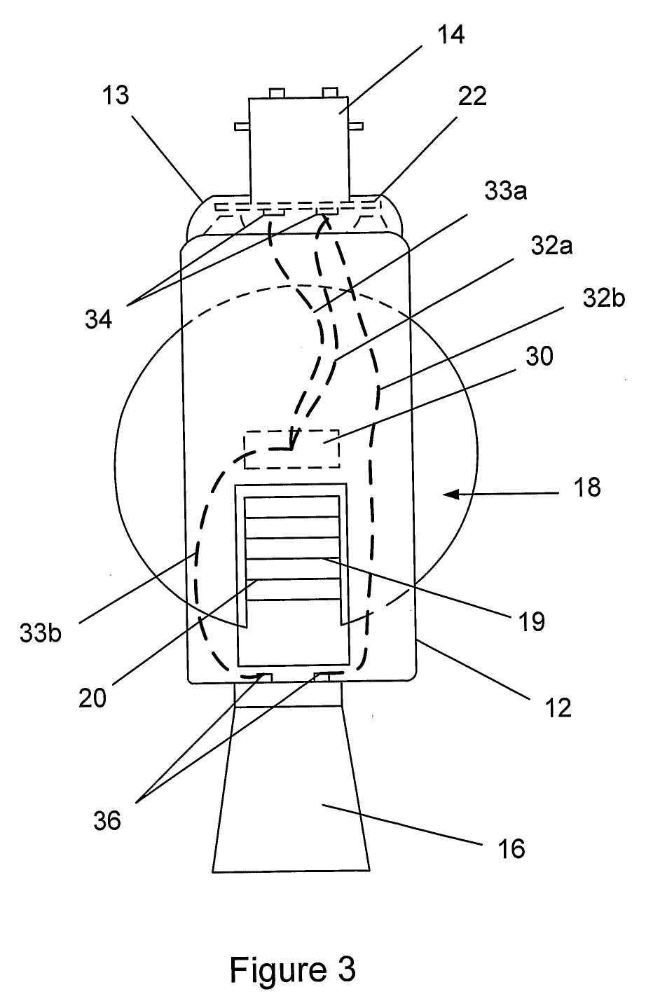

Windows 20 are provided in parts of the housing 12 adjacent the socket part 16 and extending generally between the socket part 16 and those parts of the housing 12 adjacent the housing connectors 30. The windows 20 are arranged to enable transmission of electromagnetic radiation to and from a sensor screen 19 of the motion detector 18 when the motion detector is pivoted so as to point generally downwardly (such as is shown in FIG. 3). The windows 20 are preferably holes, but may alternatively contain some kind of transmissive filter or polarising material. As shown in FIG. 3, the windows 20 are shaped so as to allow a sensing field of the motion detector 18 to extend therethrough when the motion detector 18 is in a vertically downwardly directed orientation. In this position, while the socket part 16 obscures part of the sensing field of the motion detector 18, much of the sensing field will still extend vertically and laterally outward and downward of the adaptor 10. This positional arrangement of the motion detector 18, in combination with the configuration of the windows 20 and the housing 12, allows for the adaptor 10 to be located in a light fixture in a hallway, such that the sensing field of the motion sensor 18 can extend in either direction down the hallway. Additionally, the rotational adjustability of the plug part 14 relative to the housing 12 facilitates simple adjustment of the adaptor 10 for optimal orientation thereof with respect to the hallway. If not for the rotational adjustability of the plug part 14 relative to the housing 12, the adaptor 10, once installed in the light socket, may not be able to be positioned so as to extend the sensing field in both directions down the hallway, for example because of the fixed orientation of the socket in which the adaptor 10 is installed.

The motion sensor 18 depicted in the drawings is preferably of a roughly elliptoid or spherical shape with the sensor screen 19 disposed on an outer portion thereof generally in the direction of a lateral axis of the housing 12. The inner workings of the motion sensor 18 do not form part of this invention. A motion sensor 18 for use in a preferred form of the adaptor 10 may be one that is commercially available. The motion sensor 18 receives and switches mains power. The sensor 18 itself runs on mains power received. Preferably, the motion sensor 18 has adjustable inputs for adjusting the time after which the motion detector switches off the light following the absence of any sensed motion. Also preferably, the motion sensor 18 may have a manual input adjustment for varying the ambient light level at which the sensor is enabled or disabled from operating.

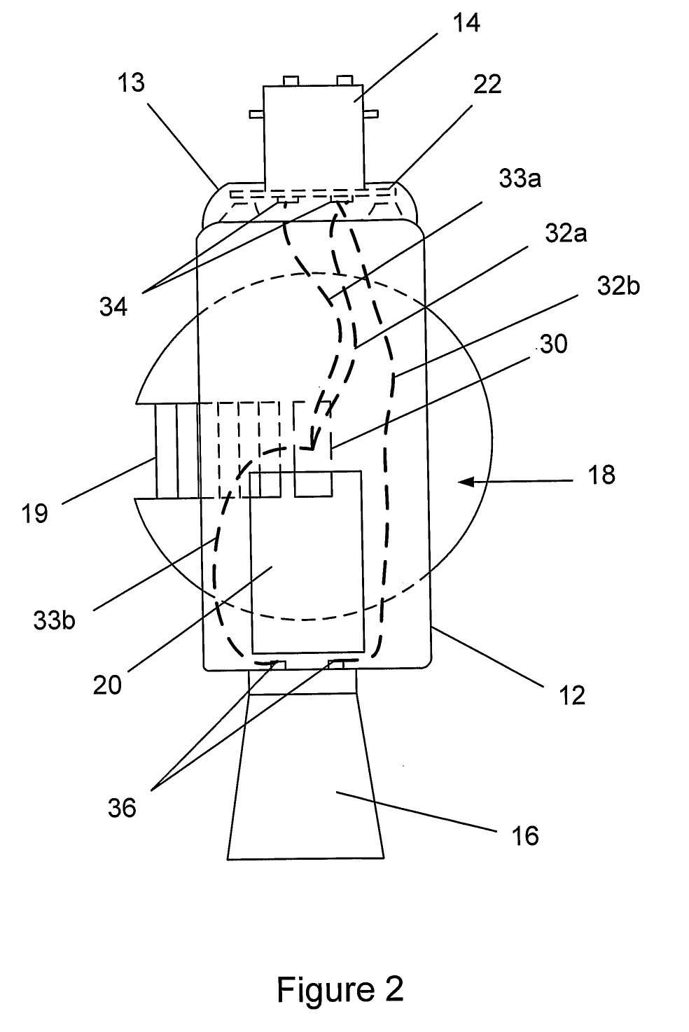

Shown in FIG. 2 is an arrangement in which the motion sensor 18 is positioned so that its sensor field is directed generally laterally. The direction of the sensor field may be altered by pivoting the motion sensor 18 about the lateral axis through the housing connectors 30, for example so as to direct the sensing field more downwardly than is depicted in FIG. 2.

Illustrated in FIGS. 2, 3 and 5 are ground conductors 32a, 32b and active conductors, 33a and 33b for powering the motion detector 18 to thus selectively switch power to a light fitted into socket part 16. The conductors are connected within the housing 12. Ground and active conductors 32a and 33a, respectively, are connected to plug terminals 34 and to the motion detector 18 (through one of the housing connectors 30). An active conductor 33b is also connected to motion detector 18 and to a socket terminal 36 associated with socket part 16, such that when the motion detector 18 senses motion, it switches active power to active conductor 33b, which is supplied to the light globe in socket part 16. A ground conductor 32b is connected between a ground terminal of the socket terminals 36 and a ground terminal of plug terminals 34 for completion of the circuit through the light globe.

In the wiring arrangement shown in the drawings there is no provision for allowing rotation of the plug part 14 or motion sensor 18 without twisting the conductors connected thereto. In an alternative embodiment (not shown) a form of intermediate electrical connector may be used to minimise the twisting effect on the conductors. In a further alternative, the plug terminals 34 may be arranged to allow for pivotal rotation of the plug part 14 without undue twisting of the conductors connected thereto and similarly with electrical connections to the motion detector 18.

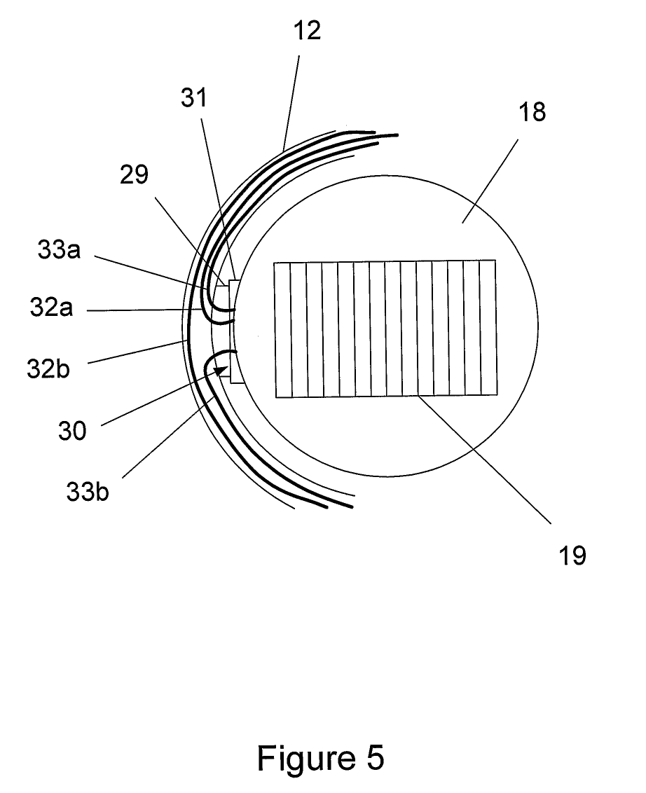

FIG. 5 further illustrates the arrangement of the conductors 32a, b and 33a, b within one side of the housing 12. Also shown in FIG. 5 are housing and connector bosses 29, 31 associated with each housing connector 30. The housing boss 29 is fixed to the housing 12, whereas the connector boss 31 rotates about the lateral axis along with rotation of the motion detector 18. The connector boss 31 is arranged to abut the housing boss 29 at the extremities of permissible rotation of the motion detector 18 relative to the housing 12, so as to limit the rotational freedom thereof to a maximum of about 350°. Preferably, the housing boss 29 and connector boss 31 are arranged so as to allow for rotation of the motion sensor 18 from the near vertical on one side of the housing 12, down through the position shown in FIG. 3 and up through to the near vertical on the other side of the housing 12, but not so as to allow rotation of more than about 350°. If excessive rotation were allowed, this may exert undue twisting stress on the conductors connected through housing connector 30. In an alternative embodiment (not shown), if an intermediate connector or other means for preventing excessive twisting stress on the conductors is employed, rotation of the motion detector 18 relative to the housing 12 in excess of 350° may be allowed, in which case housing and connector bosses 29 and 31 are not required.

FIG. 6 illustrates an alternative embodiment of the adaptor, designated by reference numeral 60. This embodiment differs from previously described embodiments only in so far as the plug and socket connections are concerned. In this embodiment, a plug part 64 is provided which allows for a screw-in connection to a socket such as those which are common in North America. A corresponding socket part 66 is provided on an opposite part of the housing 12 for receiving a screw-in light bulb having a corresponding plug form to that of plug part 64.

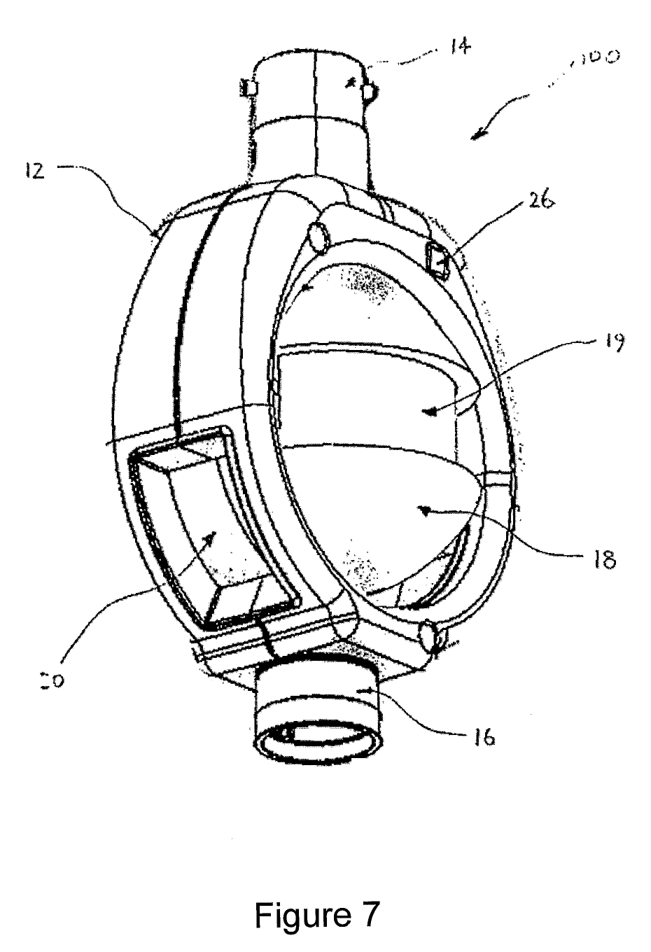

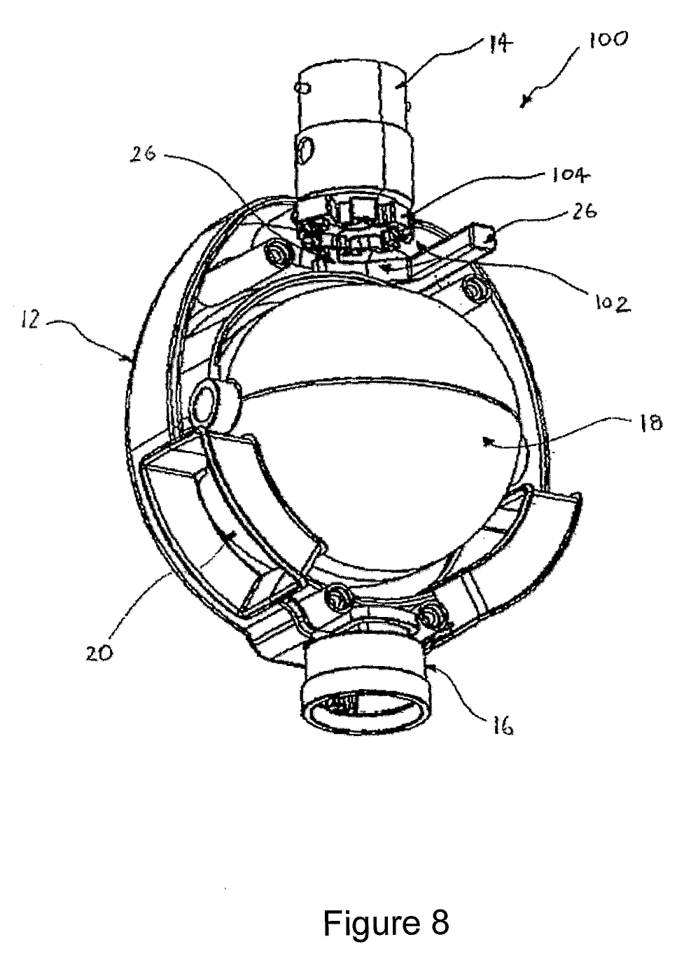

FIGS. 7 and 8 show a preferred embodiment of the adaptor, designated by reference numeral 100. This embodiment differs from previously described embodiments in its external appearance and locking mechanism 102. As shown in FIG. 8, the locking mechanism 102 comprises a ratchet wheel 104 and pawl (or locking pin) 26. The ratchet wheel 104 and pawl 26 operate in a conventional manner to lockably rotate the annular housing 12 about the male connector (or plug part) 14. The annular housing 12 is lockably rotatable about the male connector 14 up to a maximum of about 350°. The sensor 18 is similarly rotatable to a maximum of about 350°.

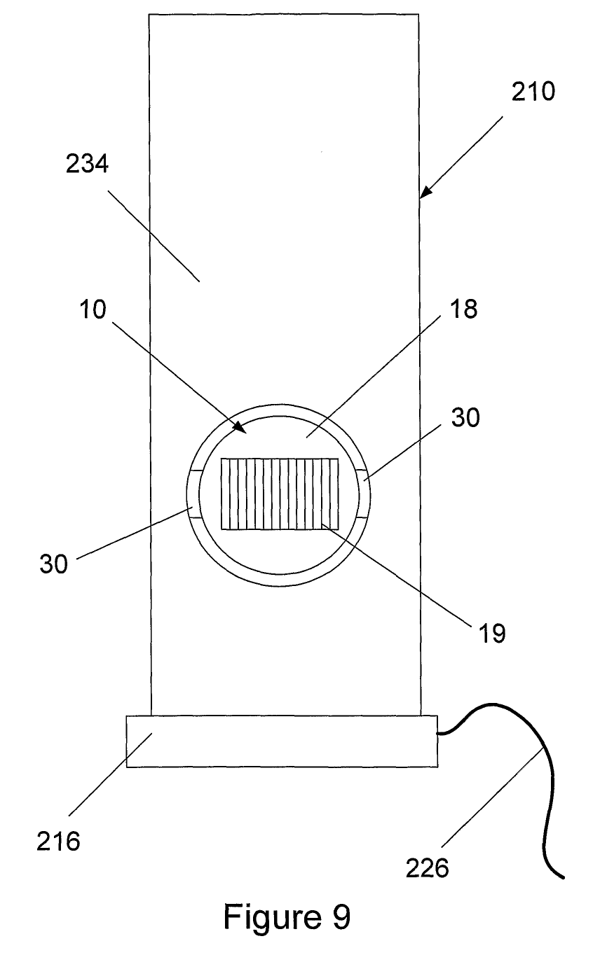

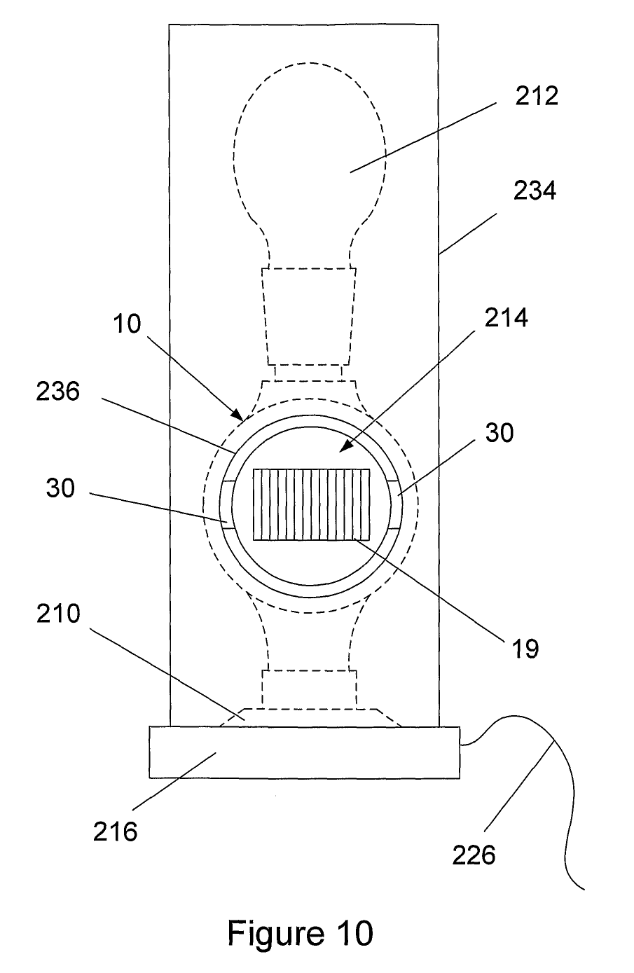

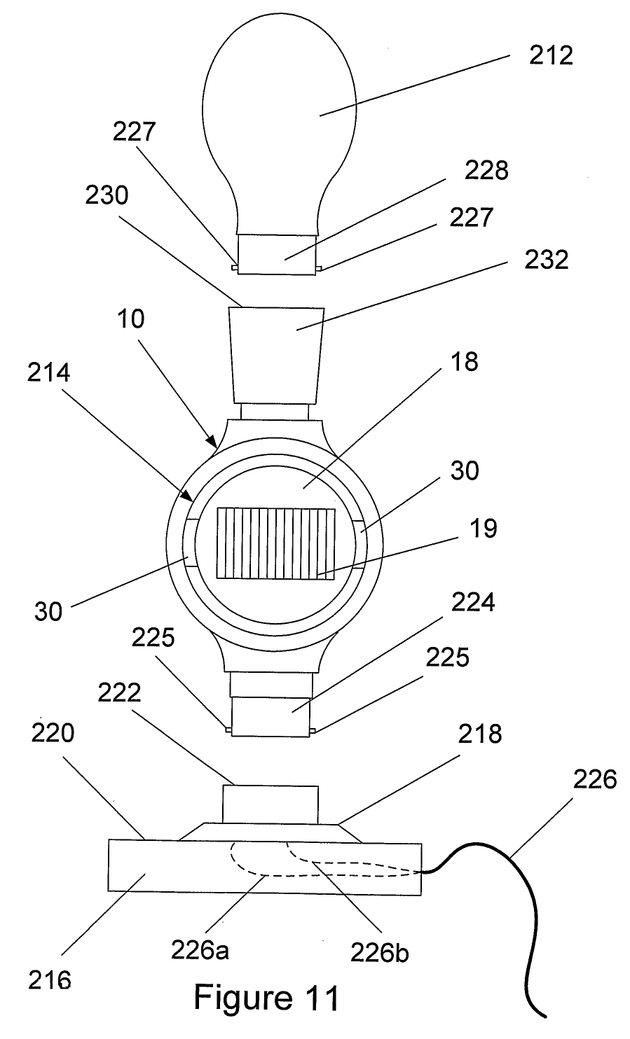

The portable device 210 shown in FIGS. 9 to 11 is used to control the operation of an electrical device 212. The portable device 210 includes a sensor 214 responsive to changes in an environment. The sensor 214 generates a control signal for activating the electric device 212 on detection of a change in the environment. The portable device 210 can be used, for example, as a bedside lamp 210 that turns on a light 212 when a person sleeping in the bed sits up or steps out of the bed. Similarly, the device 210 could be used to sound an alarm when a person sleeping in the bed sits up or steps out of the bed.

The portable device 210 shown in FIGS. 9 to 11 is a preferably lamp 210 that switches on a light bulb 212 when the sensor 214 detects movement of an object. In this embodiment, the sensor 214 forms part of the above-described adaptor 10 and is arranged between the light bulb 212 and the power source (not shown).

The lamp 210 includes a base member 216 that supports the lamp 210 in an upright position with respect to a floor or table surface, for example. A jack 218 is coupled to an upper surface 220 of the base member 216. The jack 218 includes a socket 222 shaped to receive the male end 224 of the above-described adaptor 10. The socket 222 includes active and ground electrically conductive contacts arranged for electrical communication with corresponding electrically conductive contacts of the male end 224 of the adaptor 10 when it is seated in the socket 222. The active and ground contacts are respectively electrically connected to active and ground electrically conductive wires 226a, 226b of the power lead 226. The power lead 226 electrically connects the contacts of the socket 222 to corresponding contacts of a power supply (not shown).

The male end 224 of the adaptor 10 includes first and second bayonets 225 that extend radially with respect to an opening of the socket 222. The bayonets 225 are shaped for location in corresponding channels of the socket 222. The channels (not shown) are used to locate the bayonets 225 in a fixed position in which corresponding electrically conductive contacts of the male end of the adaptor and the socket are held in electrical communication. The male end 224 of the adaptor 10 engages the socket 222 in an analogous manner to that of a standard bayonet light bulb engaging a corresponding light fitting.

The male end 228 of the light bulb 212 includes first and second bayonets 227 that extend radially with respect to an opening 230 of the female end 232 of the adaptor 10. The bayonets 227 are shaped for location in corresponding channels in the female end 232 of the adaptor 10. The channels (not shown) are used to locate the bayonets 227 in a fixed position in which corresponding electrically conductive contacts of the female end 232 of the adaptor 10. The male end 228 of the light bulb 212 engages the female end 232 of the adaptor 10 in an analogous manner to that of a standard bayonet light bulb and a corresponding light fitting.

The components of the lamp 210 are fitted together in the following manner:
1. The male end 224 of the adaptor 10 is fitted to the socket 222 of the jack 218 in the above-described manner;
2. The male end 228 of the light bulb 212 is fitted to the female end 232 of the adaptor 10 in the above-described manner; and
3. The power lead 226 is plugged into a power source.

When so arranged, the light bulb 212 is electrically coupled to the power source by the adaptor 10. As such, the sensor 214 controls the operation of the light bulb 212 by electrically coupling the light bulb to an active contact of the power source when it detects movement of an object, for example.

The lamp 210 includes a tubular screen 234 that diffuses light emitted from the light bulb 212. The screen 234 extends upwardly from the base member 216 and encompass the jack 218, adaptor 10 and the light bulb 212. The screen 234 functions as a shade for the lamp 210. The screen 234 includes an aperture 236 that is located adjacent the screen 19 of the sensor 18 of the adaptor 10. The aperture 236 is of suitable size and shape to permit the sensor 214 to detect movement of objects external to the portable device 210 therethrough.

The direction of the sensor 214 of the adaptor 10 can be adjusted in the above-described manner. The sensor 214 can be adjusted to be trained on a predetermined target such as the floor space beside a bed. In doing so, the lamp will be turned on when a person sleeping in the bed sets foot on the floor space, for example.

The portable device 210 includes an external control switch (not shown). The control switch functions as a master switch to connect and disconnect the device to the power supply.

The portable device 210 includes an external bypass switch (not shown). The bypass switch directly connects the electrical device 212 to the power supply it is when activated. The bypass switch overrides the function of the sensor 214 to control the operation of the light 212, for example.

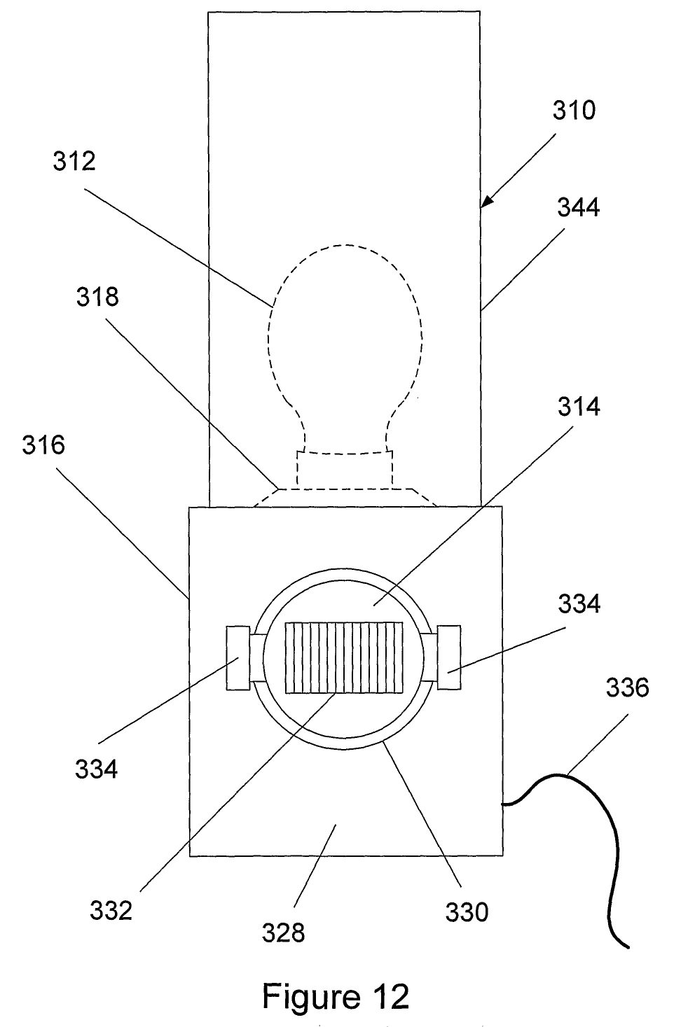

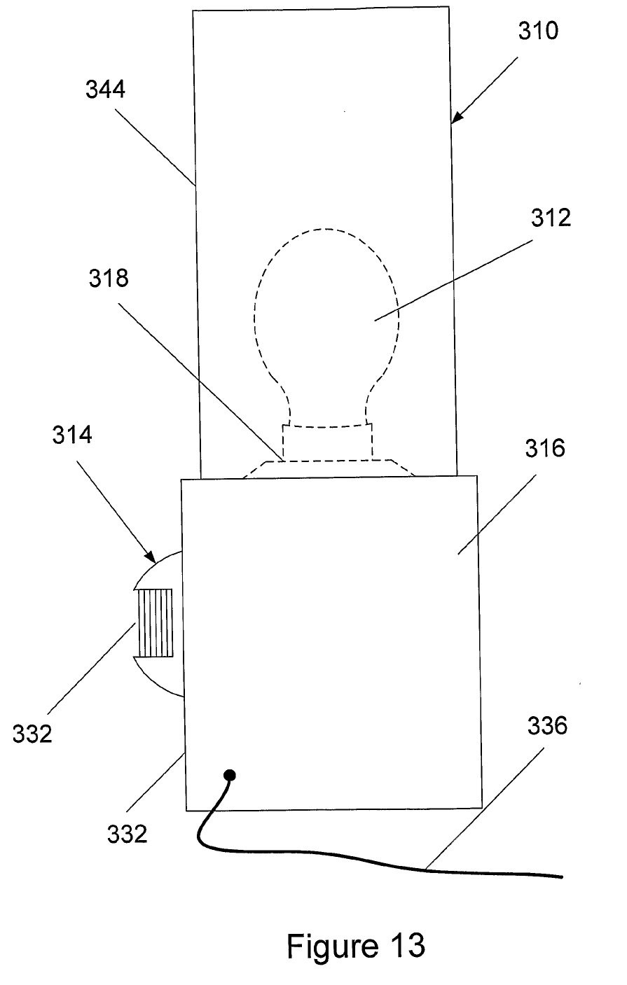

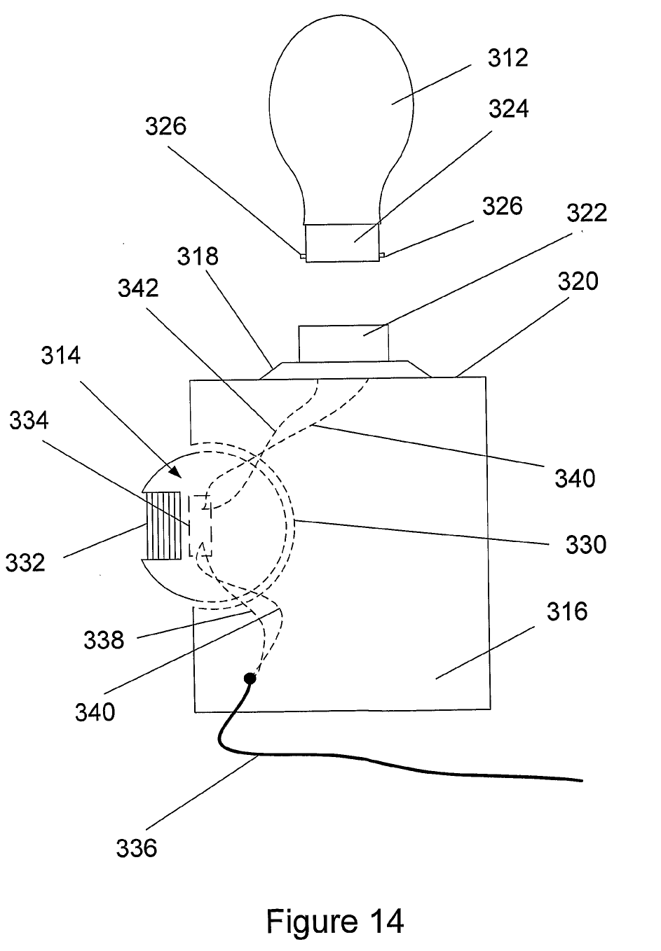

The portable device 310 shown in FIGS. 12 to 14 is used to control the operation of an electrical device 312. The portable device 310 includes a sensor 314 responsive to changes in an environment. The sensor 314 generates a control signal for activating the electric device 312 on detection of a change in the environment. The portable device 310 can be used, for example, as a bedside lamp that turns on a light 312 when a person sleeping in the bed sits up or steps out of the bed. Similarly, the device 310 could be used to sound an alarm (not shown) when a person sleeping in the bed sits up or steps out of the bed.

The portable device 310 shown in FIGS. 12 to 14 is preferably a lamp 310 that switches on a light bulb 312 when the sensor 314 detects movement of an object. In this embodiment, the sensor 314 is arranged between the light bulb 312 and the power source (not shown). The sensor 314 is preferably the above-described sensor 18 and is not limited to a motion detector, but may also be implemented using one or more of an infrared detector, a photodetector and a sound detector or any other suitable detector. Further, the sensor 314 may fixed in predetermined position with respect to the device 310.

The lamp 310 includes a base member 316 that supports the lamp 310 in an upright position with respect to a floor or table surface, for example. A jack 318 is coupled to an upper surface 320 of the base member 316. The jack 318 includes a socket 322 shaped to receive the male end 324 of the light globe 312. The socket 322 includes active and ground electrically conductive contacts arranged for electrical communication with corresponding electrically conductive contacts of the male end 324 of the light globe 312 when it is seated in the socket 322.

The male end 324 of the light globe 312 also includes first and second bayonets 326 that extend radially with respect to an opening of the socket 322. The bayonets 326 are shaped for location in corresponding channels in the socket 322. The channels (not shown) are used to locate the bayonets 326 in a fixed position in which corresponding electrically conductive contacts of the male end of the light globe 312 and the socket 322 are held in electrical communication. The male end 324 of the light globe 312 engages the socket 322 in an analogous manner to a standard bayonet light bulb being fitted to a corresponding light fitting.

A front side 328 of the base member 316 includes a generally hemispherical recessed section 330 that is shaped to at least partially receive the generally spherical sensor 314. When seated in the recessed section 330, the screen 332 of the sensor 314 opens outwardly from the base member 316.

The sensor 314 is coupled to the base member 316 by connectors 334 located on opposite sides of the sensor 314. The connectors 334 secure the sensor 314 to the base member 316 and define a lateral axis about which the senor 314 can rotate. Base and connector bosses are associated with each connector 334. The base boss is fixed to the base 316, whereas the connector boss rotates about the lateral axis along with rotation of the motion detector 314. The connector boss is arranged to abut the base boss at the extremities of permissible rotation of the motion detector 314 relative to the base member 316, so as to limit the rotational freedom thereof. Alternatively, the sensor can be coupled to the base member 316 by any other suitable means.

The lamp 310 includes a power lead 336 for electrically coupling the device 310 to a power source (not shown). The lead includes an active wire 338 and a ground wire 340. The ground wire 340 is electrically coupled to the electrically conductive ground contact of the jack 318 and to an electrically conductive ground contact of the sensor. The active wire 338 of the power lead 336 is electrically coupled to an electrically conductive active contact of the sensor 314. The sensor 314 includes a control wire 342 electrically coupled between the sensor 314 and the active contact of the jack 318.

When the sensor 314 detects an object moving in its field of view, for example, the sensor 314 generates an electric signal for the light globe 312. The active contact of the jack 318 is effectively electrically coupled to the active wire 338 of the power lead 336 and the light globe 312 is turned on, for example.

The active wire 338 and the ground wire 340 preferably extend from the power supply lead 336 into the sensor 314 through the connector 334. The control wire 342 and the ground wire preferably extend from the sensor to respective contacts of the socket 322 of the jack 318 also through the connector 334.

The lamp 310 is used by fitting the components together in the following manner:
1. The male end 324 of the light globe 312 is fitted to the socket 322 of the jack 318 in the above-described manner; and
2. The power lead 336 is plugged into a power source.

When so arranged, the light bulb 312 is electrically coupled to the power source and the sensor 314 controls the operation of the light 312. The sensor 314 controls the operation of the light bulb 312 by electrically coupling the light bulb to an active contact of the power source when it detects movement of an object, for example. The sensor can alternatively send the electric device 312 any other suitable control signal.

The lamp 310 includes a tubular screen 344 that diffuses light emitted from the light bulb 312. The screen 344 extends upwardly from the upper surface 320 base member 316 and encompass the jack 318, and the light bulb 312. The screen 344 functions as a shade for the lamp 310.

The direction of the sensor 314 can be adjusted by rotating the sensor about the lateral axis defined by the connectors 334. The sensor 314 can be adjusted to be trained on a predetermined target such as the floor space beside a bed. In doing so, the lamp 312 will turn on when a person sleeping in the bed sets foot on the floor space, for example.

The portable device 310 includes an external control switch (not shown). The control switch functions as a master switch to connect and disconnect the device to the power supply.

The portable device 310 includes an external bypass switch (not shown). The bypass switch directly connects the electrical device 312 to the power supply it is when activated. The bypass switch overrides the function of the sensor 314 to control the operation of the light 312, for example.

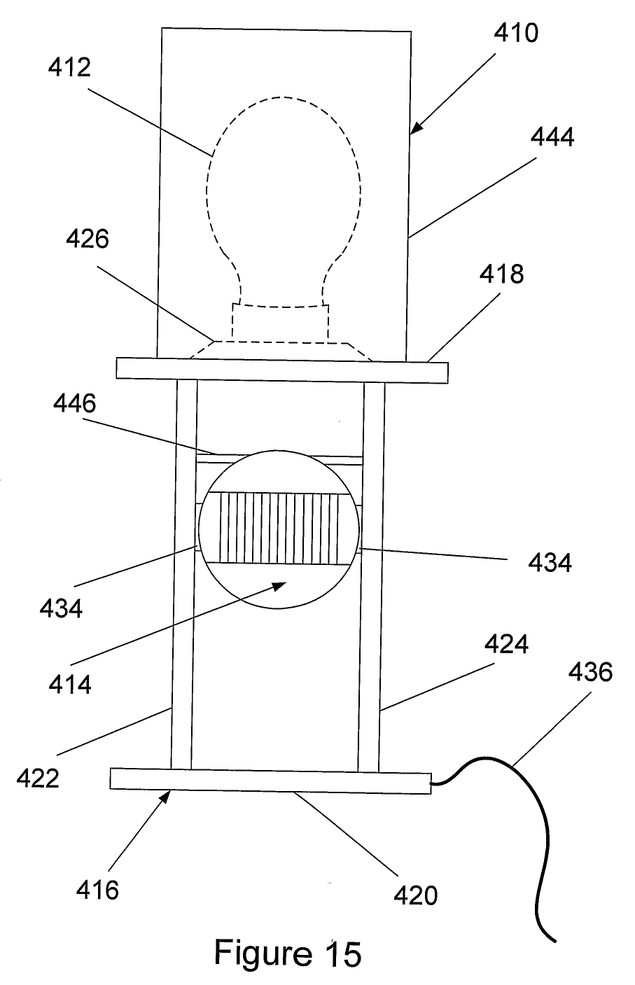

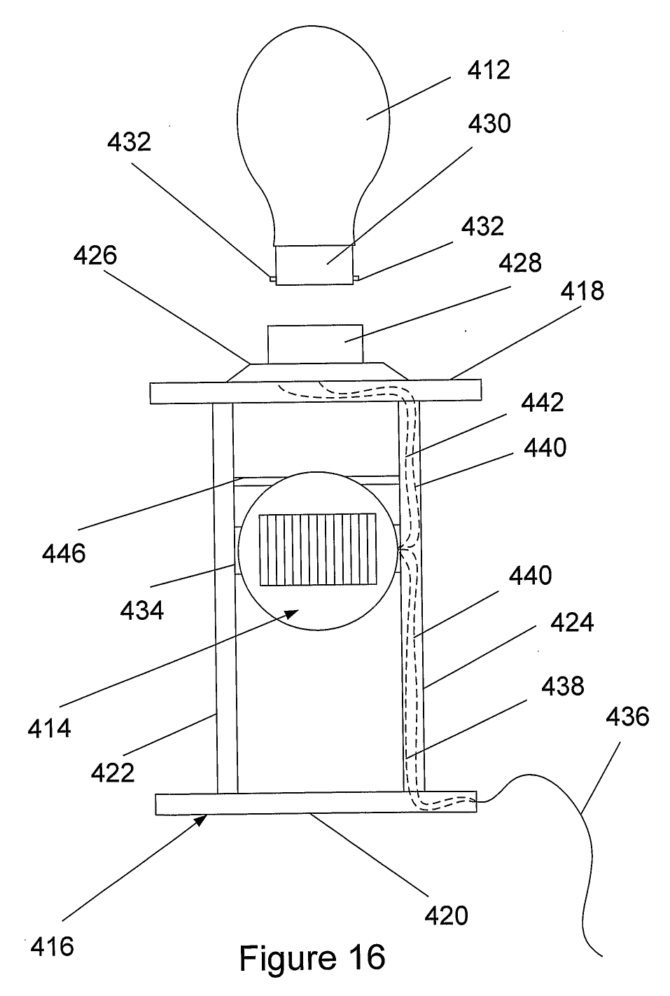

The portable device 410 shown in FIGS. 15 and 16 is used to control the operation of an electrical device 412. The portable device 410 includes a sensor 414 responsive to changes in an environment. The sensor 414 generates a control signal for activating the electric device 412 on detection of a change in the environment. The portable device 410 can be used, for example, as a bedside lamp that turns on a light 412 when a person sleeping in the bed sits up or steps out of the bed. Similarly, the device 410 could be used to sound an alarm (not shown) when a person sleeping in the bed sits up or steps out of the bed.

The portable device 410 shown in FIGS. 15 and 16 is a lamp 410 that switches on a light bulb 412 when the sensor 414 detects movement of an object. In this embodiment, the sensor 414 is arranged between the light bulb 412 and a power source (not shown). The sensor 414 is preferably the above described sensor 18 and is not limited to a motion detector, but may also be implemented using one or more of an infrared detector, a photodetector and a sound detector or any other suitable detector. Further, the sensor 314 may fixed in predetermined position with respect to the device 310.

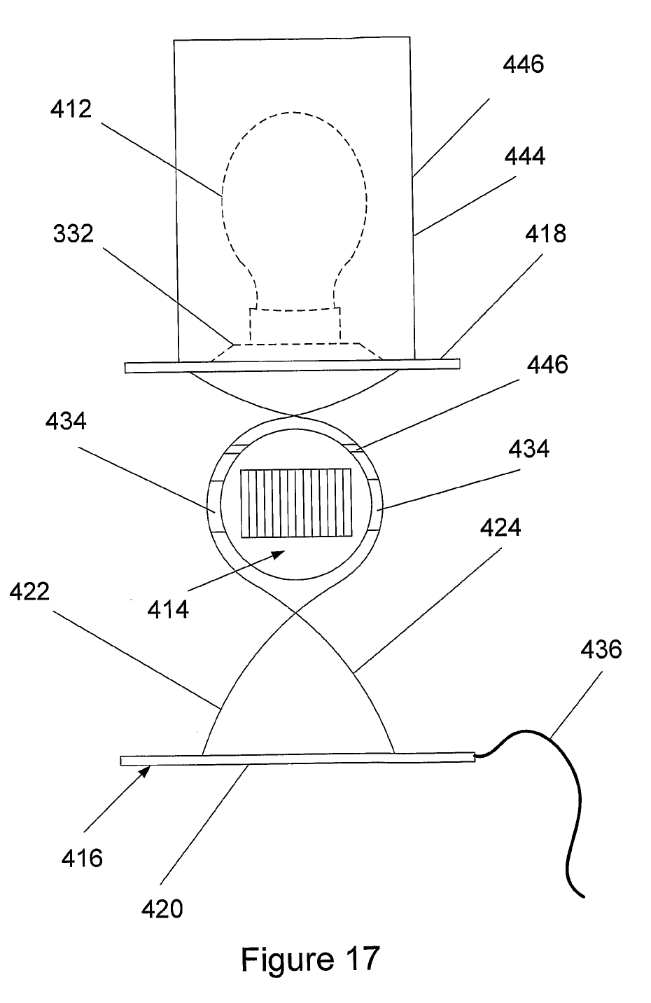

The lamp 410 includes a base member 416 that supports the lamp 410 in an upright position with respect to a floor or table surface, for example. The base member 416 includes upper and lower generally parallel platforms 418, 420 separated by spaced apart left and right posts 422, 424. The posts 422,424 are preferably parallel. However, the posts 422,424 may be arranged in the alternative arrangement shown in FIG. 17, or any other suitable form.

A jack 426 is coupled to the upper platform 418 of the base member 416. The jack 426 includes a socket 428 shaped to receive the male end 430 of the light globe 412. The socket 428 includes active and ground electrically conductive contacts arranged for electrical communication with corresponding electrically conductive contacts of the male end 430 of the light globe 412 when it is seated in the socket 428.

The male end 430 of the light globe 412 also includes first and second bayonets 432 that extend radially with respect to an opening of the socket 428. The bayonets 432 are shaped for location in corresponding channels in the socket 428. The channels (not shown) are used to locate the bayonets 432 in a fixed position in which corresponding electrically conductive contacts of the male end 430 of the light globe 412 and the socket 428 are held in electrical communication. The male end 430 of the light globe 412 engages the socket 428 in an analogous manner to a standard bayonet light bulb being fitted to a corresponding light fitting.

The sensor 414 is coupled between the left and right posts 422,424 of the base member 416 by connectors 434 located on opposite sides of the sensor 414. The connectors 434 secure the sensor 414 to the base member 416 and define a lateral axis about which the senor 414 can rotate. Base and connector bosses are associated with each connector 434. The base boss is fixed to the base 416, whereas the connector boss rotates about the lateral axis along with rotation of the motion detector 414. The connector boss is arranged to abut the base boss at the extremities of permissible rotation of the motion detector 314 relative to the base member 416, so as to limit the rotational freedom thereof. Alternatively, the sensor can be coupled to the base member 416 by any other suitable means.

The lamp 410 includes a power lead 436 for electrically coupling the device 410 to a power source (not shown). The lead 436 includes an active wire 438 and a ground wire 440. The ground wire 440 is electrically coupled to the electrically conductive ground contact of the jack 426 and to an electrically conductive ground contact of the sensor 414. The active wire 438 of the power lead 436 is electrically coupled to an electrically conductive active contact of the sensor 414. The sensor 414 also includes an electrically conductive control wire 442 electrically coupled between the sensor 414 and the active contact of the jack 426.

When the sensor 414 detects an object moving in its field of view, the sensor 414 generates a control signal for the electric device 412. The sensor 414 may simply electrically couple the active contact of the jack 426 to the active wire 438 of the lead 436. Alternatively, the sensor 414 can generate any other suitable control signal for the electric device 412.

The active wire 438 and the ground wire 440 preferably extend from the power supply lead 436 into the sensor 414 through the connector 434. The control wire 442 and the ground wire 440 preferably extend from the sensor 414 to respective contacts of the socket 428 of the jack 426 also through the connector 434.

The lamp 410 is used by fitting the components together in the following manner:
1. The male end 430 of the light globe 412 is fitted to the socket 428 of the jack 426 in the above-described manner; and
2. The power lead 436 is plugged into a power source.

When so arranged, the light bulb 412 is electrically coupled to the power source and the sensor 414 controls the operation of the light 412. The sensor 414 controls the operation of the light bulb 412 by electrically coupling the light bulb to an active contact of the power source when it detects movement of an object.

The lamp 410 includes a tubular screen 444 that diffuses light emitted from the light bulb 412. The screen 444 extends upwardly from the upper platform 418 of the base member 416 and encompass the jack 426 and the light bulb 412. The screen 444 functions as a shade for the lamp 410.

The direction of the sensor 414 can be adjusted by rotating the sensor 414 about the lateral axis defined by the connectors 434. The sensor 414 can be adjusted to be trained on a predetermined target such as the floor space beside a bed. In doing so, the lamp 412 will turn on when a person sleeping in the bed sets foot on the floor space, for example.

The lamp 410 includes a bar 446 that extends laterally between the left and right posts 422,424 of the base member 416. The bar 446 is located above the connectors 434 and inhibits full rotation of the sensor about the lateral axis defined by the connectors 434.

The left and right posts 422,424 are preferably made of 10 mm by 100 mm metal tubing. The upper and lower platforms 418,420 are preferably made of 25 mm by 135 mm metal tubing.

The portable device 410 includes an external control switch (not shown). The control switch functions as a master switch to connect and disconnect the device to the power supply.

The portable device 410 includes an external bypass switch (not shown). The bypass switch directly connects the electrical device 412 to the power supply it is when activated. The bypass switch overrides the function of the sensor 414 to control the operation of the light 412, for example.

The portable device 210,310,410 can be located on a bedside table, for example, and the sensor 214,314,414 can be trained on the floor space beside the bed. In doing so, the portable device 210,310,410 can be used to turn on a light 212,312,412 when a person steps out of bed. Similarly, the portable device 210,310,410 can be used to turn on a buzzer 212,312,412 when a person steps out of bed. Nursing staff in a hospital, for example, can use the portable device 210,310,410 to alert them that a patient has stepped out of bed.

The present invention is not limited to the particular embodiments described above, but can be implemented using different combinations of conventional electrical connections, sensors and electrical devices.

The male connector of the adaptor of the present invention is not limited to being connectable with conventional light fittings, but may also be configured to connect with conventional electrical fittings, such as wall mounted electrical sockets.

The sensor used in the adaptor or the portable device of the present invention is not limited to a motion detector, but may also be implemented using one or more of an infrared detector, a photodetector and a sound detector.

The adaptor of the present invention is not limited to connect with and control light sources, but may also be implemented to connect with and control other electrical devices such as mobile telephones or sound alarms. In these embodiments, the female connector of the adaptor may be configured to connect with a mobile telephone or sound alarm. For example, embodiments of the present invention may use the sensor to selectively control a mobile telephone so that it transmits a call to a predetermined telephone number in response to a sensed condition, such as movement. Other embodiments of the present invention may be implemented using a sound alarm so that an audible alarm is generated in response to a sensed condition. These embodiments may be used in security applications. In other security applications, the adaptor may be adapted to control a security device, such as a burglar alarm, or a monitoring device, such as a surveillance camera.

Certain modifications or enhancements to the above described embodiments may be apparent to those skilled in the art without departing from the spirit and scope of the invention.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A portable device for controlling an electric device, including a sensor responsive to changes in an environment, wherein said sensor generates a control signal for said electric device on detection of a change in said environment.

2. The portable device claimed in claim 1, including a jack for electrically coupling the electrical device to the portable device, wherein the sensor electrically couples the jack to a power source on detection of said change.

3. The portable device claimed in claim 1, wherein the electric device is a light bulb.

4. The portable device claimed in claim 2, wherein the sensor is adapted to be interconnected between the electric device and the jack.

5. The portable device claimed in claim 4, wherein the sensor is an adaptor including a gimbal mounted sensor.

6. The portable device claimed in claim 4, including a screen for diffusing light emitted by the light source.

7. The portable device claimed in claim 6, wherein the screen includes an aperture through which the sensor can detect changes in said environment.

8. The portable device claimed claim 2, wherein sensor is electrically coupled between the power source and the jack.

9. The portable device claimed in claim 8, including a base member for supporting the portable device in an upright position, wherein the jack is coupled to an upper surface of the base member.

10. The portable device claimed in claim 9, wherein the sensor is coupled to side section of the base member.

11. The portable device claimed in claim 10, wherein the sensor is adapted to rotate about an lateral axis with respect to the base member.

12. The portable device claimed in claim 8, including a screen for diffusing light emitted by the light source.

13. The portable device claimed in claim 1, wherein the sensor includes one of a motion detector, an infrared detector, a photodetector and a sound detector.

14. The portable device claimed in claim 1, wherein the electric device is an alarm.

15. The portable device claimed in claim 1, wherein the electric device is a surveillance camera.

16. The portable device claimed in claim 5, wherein the adaptor includes:
a sensor;
a gimbal housing having a male connector at one end and a female connector at another end, wherein the male connector is configured to connect with an electrical socket and the female connector is configured to connect with an electrical device; and
a circuit for selectively controlling the electrical device in response to the sensor;
wherein the gimbal housing is adapted to rotate around the male connector about a first axis and support the sensor for independent rotation about a second axis perpendicular to the first axis so that the sensor can be moved to a selectable sensing orientation.

17. The portable device claimed in claim 16, wherein the sensor comprises one of a motion detector, an infrared detector, a photodetector and a sound detector.

18. The portable device claimed in claim 16, wherein the male connector and the female connector are respectively provided on opposite ends of the gimbal housing in alignment with the first axis.

19. The portable device claimed in claim 16, wherein the electrical socket is a light socket.

20. The portable device claimed in claim 16, wherein the sensor is substantially spherical in shape and the gimbal housing is substantially annular in shape so that the sensor is supported at least partially inside the gimbal housing between the male connector and the female connector.

21. The portable device claimed in claim 16, wherein the gimbal housing further comprises a locking mechanism for lockably rotating the gimbal housing about the male connector.

22. The portable device claimed in claim 21, wherein the locking mechanism comprises a ratchet wheel and pawl.

23. The portable device claimed in claim 16, wherein the sensor is adapted to rotate less than 360° around the second axis.

24. The portable device claimed in claim 23, wherein the sensor is adapted to rotate to a maximum of about 350° around the second axis.

25. The portable device claimed in claim 16, wherein the gimbal housing is adapted to rotate less than 360° around the first axis.

26. The portable device claimed in claim 25, wherein the gimbal housing is adapted to rotate to a maximum of about 350° around the first axis.

27. A method for monitoring a person using the portable device claimed in claim 1, including the step of arranging the sensor of the portable device to monitor a predetermined area proximate said person, wherein said portable device is adapted actuate an electric device upon detection of a change in said predetermined area.
